(19) United States
(12) Patent Application Publication
(10) Pub. No.: US 2007/0133413 A1
(43) Pub. Date: Jun. 14, 2007

(54) Flow control in a video conference

(76) Inventor: Andrew Pepperell, Twickenham (GB)

Correspondence Address: STETINA BRUNDA GARRED & BRUCKER, 75 ENTERPRISE, SUITE 250, ALISO VIEJO, CA, 92656, US

(21) Appl. No.: 11/298,250

(22) Filed: Dec. 9, 2005

(51) Int. Cl. H04J 1/16

(52) U.S. Cl. 370/235

(57) ABSTRACT

In a videoconference images are not always displayed across the entirety of a viewing endpoint's screen. For example, a user may wish to view more than one videoconference participant at a time. Providing images of more than one participant can result in large amounts of bandwidth being required to transmit the data for all the images from the endpoints to the Multi-Conference Unit and maintain the resolution for all the images. Therefore, the present invention provides a method for reducing the data sent by an endpoint in response to flow control messages sent by the MCU in response to a change in the size at which the endpoint's image is being viewed.

### CROSS-REFERENCE TO RELATED APPLICATIONS

Not Applicable

### STATEMENT RE: FEDERALLY SPONSORED RESEARCH/DEVELOPMENT

Not Applicable

### FIELD OF THE INVENTION

This invention relates to a method of reducing the bandwidth of data transmitted to endpoints involved in a videoconference. It is particularly applicable to videoconferences in which one or more participants are displayed at a reduced size on the endpoints of other participants.

### BACKGROUND

In a videoconference a participant can choose how to view the other participants in a videoconference. For example one participant may choose to view only one other participant. Alternatively, all the participants may be viewed in equal sized boxes 4 as shown in FIG. 1a, or the speaker could be in a larger box 6 with the remaining participants in the conference arranged in boxes 8 around the edge of the screen as shown in FIG. 1b.

The minimised images are all sent using the original high-resolution data and thus large amounts of bandwidth can be required to transmit the number of images that are to be displayed at an endpoint. In general, it is advantageous to reduce the amount of bandwidth used to view a videoconference. This is because a high bandwidth channel is more expensive than a lower bandwidth channel. Additionally, the required bandwidth may not be present within a channel compromising the reliability of the video data stream. However, reducing the bandwidth required to transmit images across a network normally requires a reduction in the quality of the transmitted images.

One solution to this problem is provided by Radvision's MCU “Net-Save Bandwidth Optimization”, which sends an H.323 flow control message to an endpoint whose image is not being viewed, i.e. is not present within the larger box. The flow control message results in the discontinuation of the transmission of image data from that endpoint to other endpoints in a videoconference until the endpoint's image is maximized.

Thus, the Radvision MCU reduces bandwidth by preventing transmission of image data from an endpoint when the endpoint's image data is not being viewed. However, it is often useful for a participant in a videoconference to view the reactions of all the other participants and the Radvision MCU does not facilitate this.

### BRIEF SUMMARY

In accordance with one aspect of the present invention there is provided a Multi-Conference Unit (MCU) comprising a first processor for monitoring a display characteristic for data received from a first endpoint and being displayed at a second endpoint a second processor including a database comprising a mapping function for calculating an altered bit rate of data transmission from the second endpoint when the display characteristic is altered at the second endpoint and an output for transmitting a flow control message to the first endpoint specifying the bit rate at which the first endpoint should transmit its image.

The display characteristic may be the size of the an image transmitted by the first endpoint and the first processor detects a reduction in the size of the image at the second endpoint resulting in the second processor calculating a reduced bit rate for data transmission from the first endpoint.

Alternatively, when the display characteristic is the size of the an image transmitted by the first endpoint and the first processor detects an increase in the size of the image at the second endpoint resulting in the second processor calculating an increased bit rate for data transmission from the first endpoint.

If multiple endpoints are displaying the data received from the first endpoint and the display characteristic is the size of the an image transmitted by the first endpoint then the first processor monitors the maximum size the image is displayed at on any of the multiple endpoints and the second processor calculates an altered bit rate when the maximum size of the image is altered.

Preferably, the MCU further comprises a third processor for monitoring the error rate for data received from the first endpoint at an input and a fourth processor including a database comprising a mapping function for calculating an altered bit rate of data transmission from the first endpoint on detection of an altered error rate, a second output for transmitting a flow control message to the second endpoint specifying the altered bit rate at which image data should be transmitted.

In accordance with a second aspect of the present invention there is provided an MCU comprising an input for receiving data from a first endpoint a first processor for monitoring the error rate for data received at an input a second processor including a database comprising a mapping function for calculating an altered bit rate of data transmission from the endpoint on detection of an altered error rate and an output for transmitting a flow control message to the endpoint specifying the altered bit rate at which image data should be transmitted by the endpoint.

Preferably, the flow control message to reduce bit rate is sent when the error rate exceeds a first pre-determined threshold. Even more preferably a flow control message to increase bit rate is sent when the error rate falls below a second pre-determined threshold.

The second processor may only calculate the altered bit rate when the error rate has been altered for a pre-determined length of time. If this occurs then preferably the flow control message specifying a lower bit rate is transmitted after the error rate has been altered for a shorter time than for a flow control message specifying a lower bit rate.

In accordance with a third aspect of the present invention there is provided a method for enabling an MCU to alter the bit rate at which a first endpoint transmits data comprising the MCU performing the steps of registering a change in one of the group comprising: a display characteristic for data received from the first endpoint is being viewed by a second endpoint and error rate for data transmitted by the first endpoint calculating a bit rate at which the data should be transmitted by the first endpoint notifying the first endpoint of the bit rate and the first endpoint adjusting the bit rate at which it transmits data to that specified by the MCU.

Optionally, the MCU calculates a first bit rate at which data should be transmitted by the first endpoint with reference to the display characteristic and a second bit rate at which data should be transmitted by the endpoint with reference to the error rate for data transmitted by the first endpoint and notifies the first endpoint of the lowest of the first or second bit rates.

Alternatively, the MCU calculates the bit rate with reference to both the display characteristic and the error rate for data transmitted by the endpoint.

### BRIEF DESCRIPTION OF THE DRAWINGS

FIG. 1a illustrates an example of a view of a videoconference at an endpoint

FIG. 1b illustrates a second example of a view of a videoconference at an endpoint;

FIG. 2 is a flow diagram illustrating the steps of altering the bandwidth requirement for a videoconference in response to the change in the size an image is viewed at; and

FIG. 3 is a flow diagram illustrating the steps of altering the bandwidth requirement for a videoconference when the error rate for a connection changes.

### DETAILED DESCRIPTION

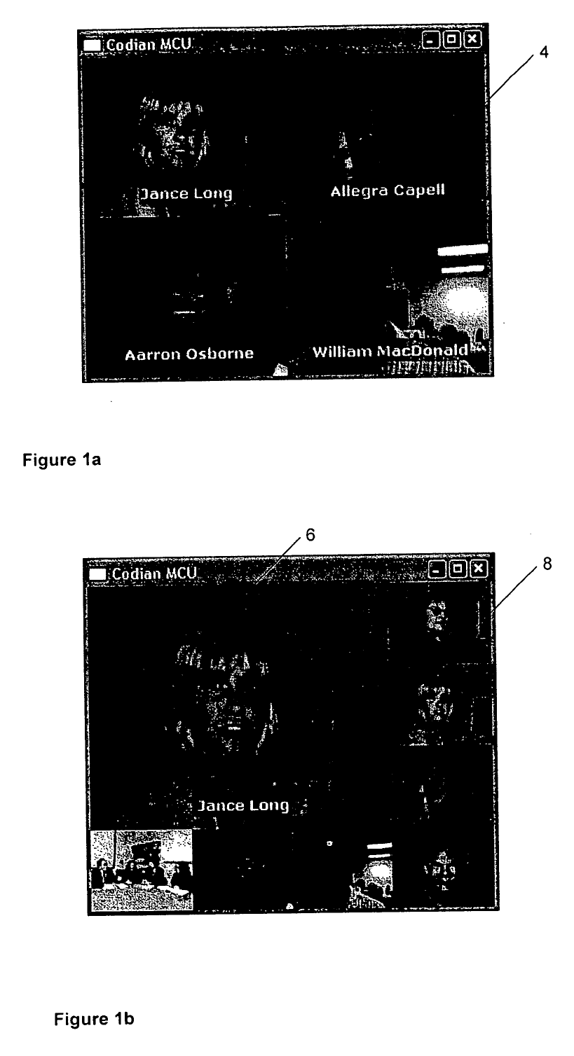

In a videoconference having more than two participants, any participant wishing to view more than one of the other participants is not able to use the entire screen to view the other participants. Rather, the screen is split up, for example, as shown in FIGS. 1a and 1b, in order to show some or all of the participants in the videoconference. The frame rate and resolution can be lower for smaller images, such as images 4 and 8 in FIGS. 1a and 1b respectively, than for larger images, such as image 6 in FIG. 1b, without the image quality being affected. This invention uses this realisation to reduce the bandwidth required to transmit the videoconference to an endpoint.

The present invention will be described with reference to a reduction in the size of an image displayed at an endpoint.

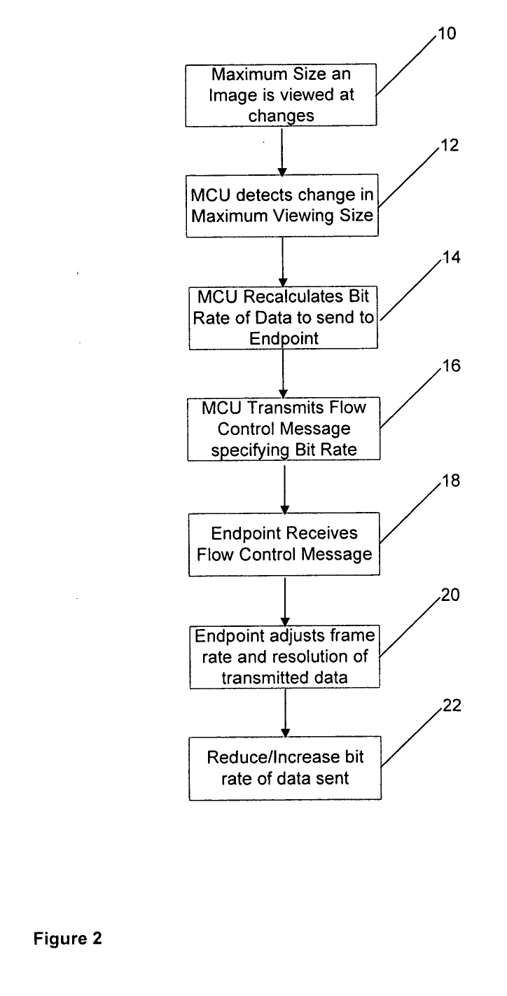

During a videoconference the MCU registers the maximum size each participating endpoint's image is being viewed at. If the maximum size of an image is reduced, for example, if a first endpoint's user stops speaking to the conference and all the other endpoint's users minimise the first endpoint's image as shown in Step 10 of FIG. 2 the MCU will detect this, as shown in Step 12. The MCU will then calculate the bit rate at which the first endpoint should transmit data, step 14, and generate a flow control message, Step 16, specifying a bit rate at which the first endpoint should transmit its image data. The flow control message may be, for example, an H.245 protocol message or a SIP message.

The MCU may calculate the bit rate using a database relating maximum image sizes to the bit rate at which images of that size should be sent to the endpoint. Alternatively, the new bit rate may be calculated as a function of the change in size of the image. The database may calculate the change in the bit rate of the data transmission directly from the new maximum size of the image or the change in the image's maximum size. Once the bit rate is calculated and the flow control message is generated the message is sent to the first endpoint.

The first endpoint, on receiving a flow control message as shown in Step 18, recalculates the resolution and frame rate of the image data to be sent to the MCU, Step 20, in order that the bit rate at which data is sent is adjusted as shown in Step 22 to be below that specified in the flow control message. The calculation of the resolution and frame rate of the image data to be sent to the MCU may be done using any appropriate means. For example, a database that relates the bit rate to the frame rate or image's resolution may be used.

The first endpoint may also contain a mapping function which links the bit rate at which the data is to be transmitted to the format in which the data is to be transmitted. Thus the MCU on calculating the appropriate bit rate for transmitting the data to the endpoint can automatically select the correct format in which the data should be transmitted, for example, CIF, 4CIF or any other appropriate format.

Conversely, when the maximum size at which an image is viewed is increased, for example, if the person speaking changes such that a second endpoint's user, previously shown in a reduced view, is now shown in an enlarged view. In this instance a flow control message is sent by the MCU to the second endpoint requesting that the endpoint's image data is transmitted at a higher bit rate. The bit rate may be calculated in the same way as described above.

In response to the flow control message the endpoint may increase the resolution or frame rate, or both, at which the data is transmitted according to a database, or mapping functions, present within the endpoint as described above.

In this way when an image is only being displayed in a small area the image data may be requested to be transmitted at a lower bit rate, reducing the bandwidth required to provide the data to the MCU. The lower bit rate transmission may be achieved by the endpoint either by reducing the frame rate or resolution or the encoding quality for the image as appropriate both of which are subjectively acceptable for a small image. An image may be either softly or sharply encoded the encoding type is determined by adjusting the quantization in the encoder. A sharply encoded image Thus, the bandwidth used by the videoconference is minimised whilst the video's quality is maintained.

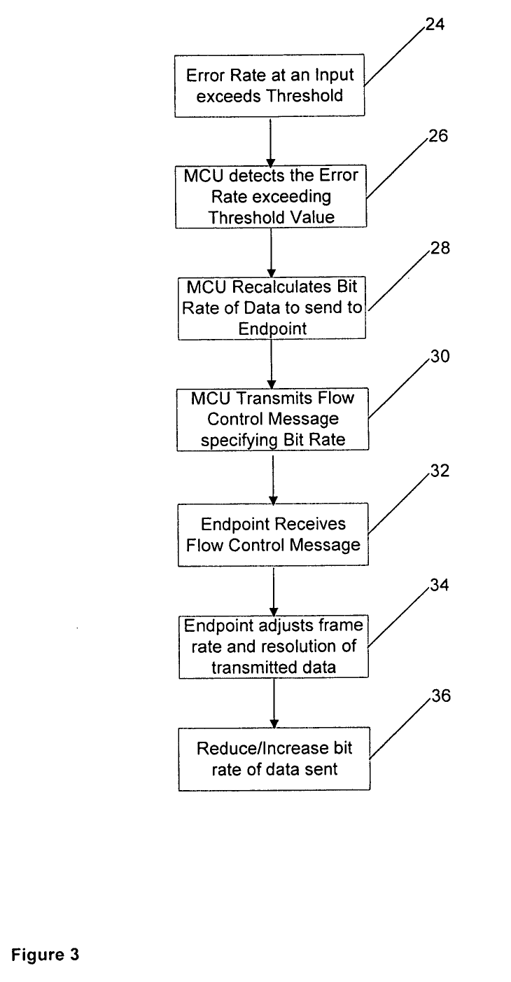

In an alternative embodiment of the present invention, illustrated in FIG. 3, flow control messages are used to adjust the bit rate at which data is sent from an endpoint in order to reduce the error rate in the data transmission from an endpoint.

In this embodiment the MCU is adapted to monitor errors that occur in data received from endpoints. The errors are caused by data packets being discarded by components within a network because the network across which the data is being transmitted can transmit less data than the amount of data being sent across it.

The alteration of an error rate, i.e. the ratio of the number of discarded packets to the total number of data packets transmitted, at an input such that it is above a first pre-determined threshold, Step 24, is detected by the MCU, Step 26. The MCU on detecting the alteration calculates a bit rate at which data packets will no longer be discarded, Step 28, and sends a flow control message to the endpoint that is transmitting the data stream, Step 30.

As before, the flow control message will specify the bit rate, calculated by an error mapping function within the MCU, at which the endpoint should transmit data. The endpoint, on receipt of the flow control message, Step 32, will adjust the resolution and frame rate at which it transmits data in response to the flow control message as described above and shown in Step 34. This will result in the bit rate at which data is sent from the endpoint being reduced, as shown in Step 36, resulting in a reduction in the number of discarded packets.

Alternatively, if the number of data packets that are being discarded is below a second pre-determined threshold then the MCU sends a flow control message specifying an increase in the bit rate to be sent by the endpoint.

Preferably, the flow control message is sent only after the error rate has been above the first pre-determined threshold or below the second pre-determined threshold for a certain period of time. Preferably, the time required to initiate a flow control message to lower the bit rate, i.e. the length of time for which the number of discarded messages is above the threshold, is shorter than that required to raise the bit rate. This is done in order to avoid jitter about an optimum bandwidth.

The final bit rate at which the endpoint will transmit its data may be determined either by taking into account both the size at which an endpoint's image is being viewed and the error rate for the data stream from a particular endpoint and then calculating the optimal bit rate. Alternatively, and more preferably, the optimal bit rate for transmitting data having a maximum size at which the image is being viewed and the optimal bit rate for the error rate of the received data are calculated separately. This allows the bit rate resulting in the maximum quality of image with minimum bandwidth usage, rather than an intermediate bit rate, i.e. the lowest bit rate to be selected.

As the type of codec being used by an endpoint is specified by the endpoint when it connects to the MCU it is preferable that the MCU adjusts the bit rate specified in the flow control message accordingly. This means that the bit rate for an inefficient codec is lowered less than for a more efficient codec whose maximum image size or error rate are the same. Additionally, a minimum bit rate may be set for a codec type such that the codec may not be requested to lower its bit rate below a specified value. The variation of the bit rate specified by the MCU for different types of codecs allows the MCU to maximise the quality of the images received from all the endpoints.

According to a third embodiment of the present invention the MCU monitors the transmission of data to a viewing endpoint participating in a videoconference. As discussed previously, with reference to FIGS. 1a and 1b a user may use a number of different layouts to display participants in a videoconference. It therefore, may be advantageous to monitor the display layouts and alter the data transmission to an endpoint according to the display layout it is using.

In order to achieve this the MCU can monitor the data received from all the endpoints which are being combined to form the composite image being viewed by the viewing endpoint. Additionally, it will also monitor how the composite image is being viewed by the endpoint, for example whether it is being viewed using the layout shown in FIG. 1a or the layout shown in FIG. 1b. The MCU may then analyse the data received in order to transmit the composite image in a format which enables the MCU to maintain the quality of the viewed images.

One example of an implementation of this technique is if, for example, each of the endpoints transmitting the images which form the composite image, as shown in FIG. 1a, transmit their images in CIF (352×288 resolution). The images in FIG. 1a are displayed in relatively large frames and it is therefore desirable to maintain the resolution of the images at the level at which they were transmitted.

In order to achieve this the MCU recognises that the images are being transmitted using CIF and that all of the images are being displayed in a layout where resolution of the images should be maintained. Thus, in order to maintain the images' resolution the MCU will transmit the composite image using 4CIF (704×576 resolution).

In a further example, the endpoint may be displaying images in a layout as shown in FIG. 1b. As discussed above smaller images can be displayed at lower resolutions and frame rates without any noticeable effect on the quality of the images. The MCU will therefore recognise that not all the images forming the composite image need to be transmitted at the resolution at which they are received and will modify the resolution at which it transmits the composite image to the endpoint accordingly.

What is claimed is:

1. A Multi-Conference Unit (MCU) comprising:
(i) a first processor for monitoring a display characteristic for data received from a first endpoint and being displayed at a second endpoint;
(ii) a second processor including a database comprising a mapping function for calculating an altered bit rate of data transmission from the first endpoint when the display characteristic is altered at the second endpoint; and
(iii) an output for transmitting a flow control message to the first endpoint specifying the bit rate at which the first endpoint should transmit its image.

2. An MCU as claimed in claim 1 wherein the display characteristic is the size of the image transmitted by the first endpoint and the first processor detects a reduction in the size of the image at the second endpoint resulting in the second processor calculating a reduced bit rate for data transmission from the first endpoint.

3. An MCU as claimed in claim 1 wherein the display characteristic is the size of the image transmitted by the first endpoint and the first processor detects an increase in the size of the image at the second endpoint resulting in the second processor calculating an increased bit rate for data transmission from the first endpoint.

4. An MCU as claimed in claim 1 wherein the display characteristic is the size of the image transmitted by the first endpoint and the image is displayed at multiple second endpoints and the first processor monitors the maximum size the image is displayed at on any of the multiple endpoints and the second processor calculates an altered bit rate when the maximum size of the image is altered.

5. An MCU as claimed in claim 1 wherein the MCU further comprises a third processor for monitoring the error rate for data received from the first endpoint at an input and a fourth processor including a database comprising a mapping function for calculating an altered bit rate of data transmission from the first endpoint on detection of an altered error rate, a second output for transmitting a flow control message to the second endpoint specifying the altered bit rate at which image data should be transmitted.

6. A Multi-Conference Unit (MCU) comprising:
(i) an input for receiving data from a first endpoint;
(ii) a first processor for monitoring the error rate of data received at an input and generating a message when the error rate crosses a first pre-determined threshold;
(iii) a second processor including a database comprising a mapping function, the database calculating a desired bit rate of data transmission on receipt of the message; and
(iv) an output for transmitting a flow control message to the endpoint specifying the desired bit rate at which image data should be transmitted by the endpoint.

7. An MCU as claimed in claim 6 wherein a flow control message to reduce bit rate is sent when the error rate exceeds the first pre-determined threshold.

8. An MCU as claimed in claim 6 wherein a flow control message to increase bit rate is sent when the error rate falls below the first pre-determined threshold.

9. An MCU as claimed in claim 6 wherein the second processor only calculates the desired bit rate when the error rate has crossed the threshold for a pre-determined length of time.

10. An MCU as claimed in claim 6 wherein:
(i) a flow control message to reduce bit rate is generated after the first pre-determined threshold has been exceeded for a first period of time;
(ii) a flow control message to increase bit rate is generated after the error rate has fallen below the first pre-determined threshold for a second period of time; the first period of time being shorter than the second period of time.

11. An MCU as claimed in claim 6 wherein:
(i) a flow control message to reduce bit rate is generated after the first pre-determined threshold has been exceeded for a period of time;
(ii) a flow control message to increase bit rate is generated after the error rate has fallen below the first pre-determined threshold for an equal period of time.

12. An MCU as claimed in claim 6 wherein
a flow control message to reduce bit rate is sent when the error rate exceeds a first pre-determined threshold and
the flow control message to increase bit rate is sent when the error rate falls below a second pre-determined threshold,
the first pre-determined threshold being for a higher error rate than the second pre-determined threshold.

13. An MCU as claimed in claim 12 wherein:
(i) the flow control message to reduce bit rate is generated after the first pre-determined threshold has been exceeded for a first period of time;
(ii) the flow control message to increase bit rate is generated after the error rate has fallen below the second pre-determined threshold for a second period of time; the first period of time being shorter than the second period of time.

14. An MCU as claimed in claim 12 wherein:
(i) the flow control message to reduce bit rate is generated after the first pre-determined threshold has been exceeded for a first period of time;
(ii) the flow control message to increase bit rate is generated after the error rate has fallen below the second pre-determined threshold for a second period of time; the first period of time being equal to the second period of time.

15. A Multi-Conference Unit (MCU) comprising:
(i) a first processor for monitoring a display characteristic for data transmitted to an endpoint;
(ii) a second processor for monitoring a characteristic of data received by the MCU and being processed for sending to the endpoint
(iii) a third processor including a database comprising a mapping function for calculating a format for transmitting the data according to the data's display characteristic and the characteristic of the data received by the MCU.

16. An MCU as claimed in claim 15 wherein the display characteristic is the layout of images displayed at the endpoint and transmitted by the MCU to the endpoint.

17. An MCU as claimed in claim 15 wherein the characteristic of the data is the resolution of an image transmitted by the data.

18. A method for enabling an MCU to alter the bit rate at which a first endpoint transmits data comprising the MCU performing the steps of:
(i) registering a change in one of the group comprising: a display characteristic for data received from the first endpoint that is being viewed by a second endpoint and error rate for data transmitted by the first endpoint;
(ii) calculating a bit rate at which the data should be transmitted by the first endpoint;
(iii) notifying the first endpoint of the bit rate; and the first endpoint adjusting the bit rate at which it transmits data to that specified by the MCU.

19. A method as claimed in claim 18 wherein the MCU calculates a first bit rate at which data should be transmitted by the first endpoint with reference to the display characteristic and a second bit rate at which data should be transmitted by the endpoint with reference to the error rate for data transmitted by the first endpoint and notifies the first endpoint of the lowest of the first or second bit rates.

20. A method as claimed in claim 18 wherein the MCU calculates the bit rate with reference to both the size at which image data from the endpoint is being viewed and the error rate for data transmitted by the endpoint.
